(19) United States
(12) Patent Application Publication
(10) Pub. No.: US 2024/0365339 A1
(43) Pub. Date: Oct. 31, 2024

(54) PERFORMING COMMUNICATIONS USING A SET OF SCHEDULING CONFIGURATIONS

(71) Applicant: Lenovo (Singapore) Pte. Ltd., New Tech Park (SG)

(72) Inventors: Hyejung Jung, Northbrook, IL (US); Hossein Bagheri, Urbana, IL (US); Vijay Nangia, Woodridge, IL (US)

(21) Appl. No.: 18/684,318

(22) PCT Filed: Aug. 16, 2022
(86) PCT No.: PCT/IB2022/057678

§ 371 Date: Feb. 16, 2024

Related U.S. Application Data
(60) Provisional application No. 63/234,128, filed on Aug. 17, 2021.

(51) Int. Cl. H04W 72/232; H04L 1/00; H04L 5/00; H04W 72/0446; H04W 72/0453

(52) U.S. Cl. CPC H04W 72/232; H04L 1/0003; H04L 5/0055; H04W 72/0446; H04W 72/0453

(57) ABSTRACT

Apparatuses, methods, and systems are disclosed for performing communications using a set of scheduling configurations. One method includes receiving, at a user equipment, information indicating at least one set of scheduling configurations. Each set of scheduling configurations of the at least one set of scheduling configurations includes at least one scheduling configuration, and each scheduling configuration of the at least one scheduling configuration includes scheduling information including time domain resource allocations, frequency domain resource allocations, a modulation and coding scheme (“MCS”), or some combination thereof. The method includes receiving downlink control information (“DCI”) that indicates activation of a set of scheduling configurations of the at least one set of scheduling configurations for a duration. The method includes performing communications on a plurality of scheduling occasions of the set of scheduling configurations. The plurality of scheduling occasions is within the duration.

### CROSS-REFERENCE TO RELATED APPLICATIONS

This application claims priority to U.S. Patent Application Ser. No. 63/234,128 entitled “APPARATUSES, METHODS, AND SYSTEMS FOR SCHEDULING ENHANCEMENTS FOR EXTENDED REALITY COMMUNICATIONS” and filed on Aug. 17, 2021 for Hyejung Jung et al., which is incorporated herein by reference in its entirety.

### FIELD

The subject matter disclosed herein relates generally to wireless communications and more particularly relates to performing communications using a set of scheduling configurations.

### BACKGROUND

In certain wireless communications systems, extended reality (“XR”) may be used. In such systems, there may be various data requirements.

### BRIEF SUMMARY

Methods for performing communications using a set of scheduling configurations are disclosed. Apparatuses and systems also perform the functions of the methods. One embodiment of a method includes receiving, at a user equipment (“UE”), information indicating at least one set of scheduling configurations. Each set of scheduling configurations of the at least one set of scheduling configurations includes at least one scheduling configuration, and each scheduling configuration of the at least one scheduling configuration includes scheduling information including time domain resource allocations, frequency domain resource allocations, a modulation and coding scheme (“MCS”), or some combination thereof. In some embodiments, the method includes receiving downlink control information (“DCI”) that indicates activation of a set of scheduling configurations of the at least one set of scheduling configurations for a duration. In certain embodiments, the method includes performing communications on a plurality of scheduling occasions of the set of scheduling configurations. The plurality of scheduling occasions is within the duration.

One apparatus for performing communications using a set of scheduling configurations includes a transceiver to: receive information indicating at least one set of scheduling configurations, wherein each set of scheduling configurations of the at least one set of scheduling configurations includes at least one scheduling configuration, and each scheduling configuration of the at least one scheduling configuration includes scheduling information including time domain resource allocations, frequency domain resource allocations, a MCS, or some combination thereof: receive DCI that indicates activation of a set of scheduling configurations of the at least one set of scheduling configurations for a duration; and perform communications on a plurality of scheduling occasions of the set of scheduling configurations, wherein the plurality of scheduling occasions is within the duration.

Another embodiment of a method for performing communications using a set of scheduling configurations includes transmitting, at a network device, information indicating at least one set of scheduling configurations. Each set of scheduling configurations of the at least one set of scheduling configurations includes at least one scheduling configuration, and each scheduling configuration of the at least one scheduling configuration includes scheduling information including time domain resource allocations, frequency domain resource allocations, a MCS, or some combination thereof. In some embodiments, the method includes transmitting DCI that indicates activation of a set of scheduling configurations of the at least one set of scheduling configurations for a duration. In certain embodiments, the method includes performing communications on a plurality of scheduling occasions of the set of scheduling configurations. The plurality of scheduling occasions is within the duration.

Another apparatus for performing communications using a set of scheduling configurations includes a transceiver to: transmit information indicating at least one set of scheduling configurations, wherein each set of scheduling configurations of the at least one set of scheduling configurations includes at least one scheduling configuration, and each scheduling configuration of the at least one scheduling configuration includes scheduling information including time domain resource allocations, frequency domain resource allocations, a MCS, or some combination thereof: transmit DCI that indicates activation of a set of scheduling configurations of the at least one set of scheduling configurations for a duration; and perform communications on a plurality of scheduling occasions of the set of scheduling configurations, wherein the plurality of scheduling occasions is within the duration.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for performing communications using a set of scheduling configurations;

FIG. 2 is a schematic block diagram illustrating one embodiment of an apparatus that may be used for performing communications using a set of scheduling configurations:

FIG. 3 is a schematic block diagram illustrating one embodiment of an apparatus that may be used for performing communications using a set of scheduling configurations:

FIG. 4 is a schematic block diagram illustrating one embodiment of a joint configured grant confirmation medium access control (“MAC”) control element (“CE”);

FIG. 5 is a flow chart diagram illustrating one embodiment of a method for performing communications using a set of scheduling configurations; and

FIG. 6 is a flow chart diagram illustrating another embodiment of a method for performing communications using a set of scheduling configurations.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising.” “having.” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

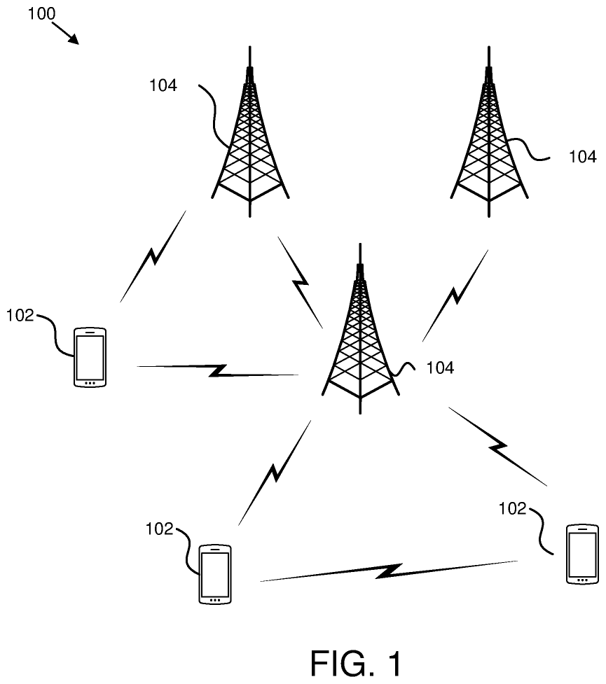

FIG. 1 depicts an embodiment of a wireless communication system 100 for performing communications using a set of scheduling configurations. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an OFDM modulation scheme on the downlink (“DL”) and the remote units 102 transmit on the uplink (“UL”) using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth R, ZigBee, Sigfox, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a remote unit 102 may receive information indicating at least one set of scheduling configurations. Each set of scheduling configurations of the at least one set of scheduling configurations includes at least one scheduling configuration, and each scheduling configuration of the at least one scheduling configuration includes scheduling information including time domain resource allocations, frequency domain resource allocations, a MCS, or some combination thereof. In some embodiments, the remote unit 102 may receive DCI that indicates activation of a set of scheduling configurations of the at least one set of scheduling configurations for a duration. In certain embodiments, the remote unit 102 may perform communications on a plurality of scheduling occasions of the set of scheduling configurations. The plurality of scheduling occasions is within the duration. Accordingly, the remote unit 102 may be used for performing communications using a set of scheduling configurations.

In certain embodiments, a network unit 104 may transmit information indicating at least one set of scheduling configurations. Each set of scheduling configurations of the at least one set of scheduling configurations includes at least one scheduling configuration, and each scheduling configuration of the at least one scheduling configuration includes scheduling information including time domain resource allocations, frequency domain resource allocations, a MCS, or some combination thereof. In some embodiments, the network unit 104 may transmit DCI that indicates activation of a set of scheduling configurations of the at least one set of scheduling configurations for a duration. In certain embodiments, the network unit 104 may perform communications on a plurality of scheduling occasions of the set of scheduling configurations. The plurality of scheduling occasions is within the duration. Accordingly, the network unit 104 may be used for performing communications using a set of scheduling configurations.

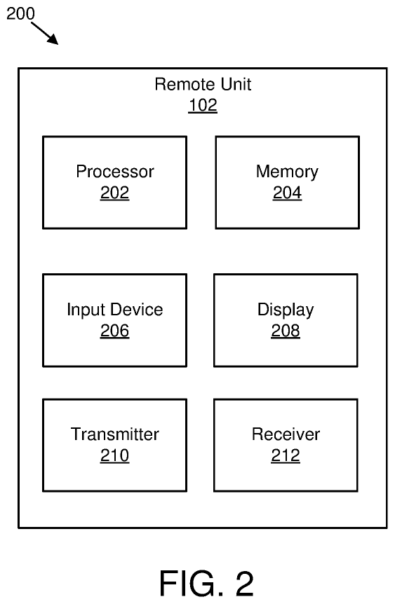

FIG. 2 depicts one embodiment of an apparatus 200 that may be used for performing communications using a set of scheduling configurations. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

In certain embodiments, the transceiver to: receive information indicating at least one set of scheduling configurations, wherein each set of scheduling configurations of the at least one set of scheduling configurations includes at least one scheduling configuration, and each scheduling configuration of the at least one scheduling configuration includes scheduling information including time domain resource allocations, frequency domain resource allocations, a MCS, or some combination thereof: receive DCI that indicates activation of a set of scheduling configurations of the at least one set of scheduling configurations for a duration; and perform communications on a plurality of scheduling occasions of the set of scheduling configurations, wherein the plurality of scheduling occasions is within the duration.

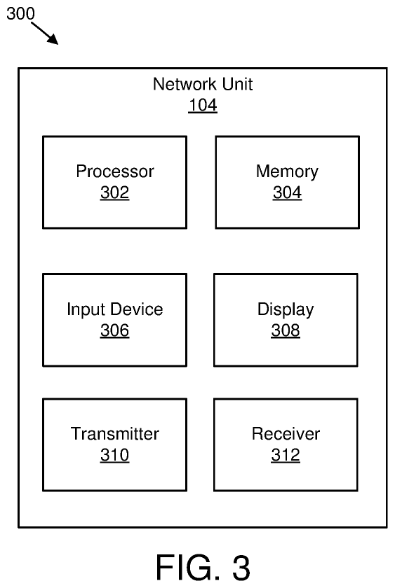

FIG. 3 depicts one embodiment of an apparatus 300 that may be used for performing communications using a set of scheduling configurations. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, the transceiver to: transmit information indicating at least one set of scheduling configurations, wherein each set of scheduling configurations of the at least one set of scheduling configurations includes at least one scheduling configuration, and each scheduling configuration of the at least one scheduling configuration includes scheduling information including time domain resource allocations, frequency domain resource allocations, a MCS, or some combination thereof; transmit DCI that indicates activation of a set of scheduling configurations of the at least one set of scheduling configurations for a duration; and perform communications on a plurality of scheduling occasions of the set of scheduling configurations, wherein the plurality of scheduling occasions is within the duration.

It should be noted that one or more embodiments described herein may be combined into a single embodiment.

In certain embodiments, in XR applications such with immersive online gaming and a smart helmet, there may be a latency-sensitive set of data collected from multiple cooperating sensors and/or devices (e.g., motion sensors, cameras, and audio devices) of a UE may need to be uploaded to an XR edge server within a certain time window for real-time rendering and/or virtual control of machines or other objects. Similarly, multiple packets of different quality of service (“QoS”) requirements for the multiple cooperating devices of the UE may need to be downloaded from an application server in a quasi-synchronous manner.

In some embodiments, each packet of a set of associated packets from and/or to each sensor and/or device of a UE may have a different arrival rate and different requirements (e.g., one packet with ultra-reliable low-latency communication (“URLLC”) requirements (e.g., high reliability and ultra-low latency such as a 10⁻⁶ target block error rate and less than 1 millisecond air interface latency) and another packet with enhanced mobile broadband (“MBB”) requirements (e.g., downlink data rate of 0.5-1 Gbps and latency of 5-10 ms). From a physical-layer perspective, multiple transport blocks (“TBs”) of different sizes and of different periodicities may need to be transmitted and/or received by the UE based on different MCS.

In various embodiments, there may be methods to accommodate multiple traffics of different QoS requirements in a quasi-synchronous manner and to increase system capacity based on reduced DL and UL control signaling overheads.

In certain embodiments, there may be details for activation and/or deactivation of DL semi-persistent scheduling (“SPS”) and UL grant type 2.

In some embodiments, there may be physical downlink control channel (“PDCCH”) validation for DL SPS and UL grant Type 2.

A UE validates, for scheduling activation or scheduling release, a DL SPS assignment PDCCH or a configured UL grant Type 2 PDCCH if:
1) the cyclic redundancy check (“CRC”) of a corresponding DCI format is scrambled with a configured scheduling (“CS”) radio network temporary identifier (“RNTI”) (“CS-RNTI”) provided by cs-RNTI;
2) the new data indicator field in the DCI format for the enabled transport block is set to ‘0’;
3) the DFI flag field, if present, in the DCI format is set to ‘0’; and
4) if validation is for scheduling activation and if the physical downlink shared channel (“PDSCH”)-to-HARQ_feedback timing indicator field in the DCI format is present, the PDSCH-to-HARQ_feedback timing indicator field does not provide an inapplicable value from dl-DataToUL-ACK-r16.

If a UE is provided a single configuration for UL grant Type 2 physical uplink shared channel (“PUSCH”) or for SPS PDSCH, validation of the DCI format is achieved if all fields for the DCI format are set according to Table 1 or Table 2.

If a UE is provided more than one configuration for UL grant Type 2 PUSCH or for SPS PDSCH, a value of the hybrid automatic repeat request (“HARQ”) process number field in a DCI format indicates an activation for a corresponding UL grant Type 2 PUSCH or for a SPS PDSCH configuration with a same value as provided by ConfiguredGrantConfigIndex or by sps-ConfigIndex, respectively. Validation of the DCI format is achieved if the RV field for the DCI format is set as in Table 3.

If a UE is provided more than one configuration for UL grant Type 2 PUSCH or for SPS PDSCH:
1) if the UE is provided ConfiguredGrantConfigType2DeactivationStateList or sps-ConfigDeactivationStateList, a value of the HARQ process number field in a DCI format indicates a corresponding entry for scheduling release of one or more UL grant Type 2 PUSCH or SPS PDSCH configurations; and
2) if the UE is not provided ConfiguredGrantConfigType2DeactivationStateList or sps-ConfigDeactivationStateList, a value of the HARQ process number field in a DCI format indicates a release for a corresponding UL grant Type 2 PUSCH or for a SPS PDSCH configuration with a same value as provided by ConfiguredGrantConfigIndex or by sps-ConfigIndex, respectively.

Validation of the DCI format is achieved if all fields for the DCI format are set according to Table 4.

If validation is achieved, the UE considers the information in the DCI format as a valid activation or valid release of DL SPS or configured UL grant Type 2. If validation is not achieved, the UE discards all the information in the DCI format.

TABLE 1
Special fields for single DL SPS or single UL grant Type 2
scheduling activation PDCCH validation when a UE is provided
a single SPS PDSCH or UL grant Type 2 configuration in the
active DL/UL bandwidth part (“BWP”) of the scheduled cell

| | DCI format | DCI format | DCI format |
|---|---|---|---|
| | 0_0/0_1/0_2 | 1_0/1_2 | 1_1 |
| HARQ process | set to all ‘0’s | set to all ‘0’s | set to all ‘0’s |
| number | | | |
| Redundancy | set to all ‘0’s | set to all ‘0’s | For the enabled transport |
| version | | | block: set to all ‘0’s |

TABLE 2
Special fields for single DL SPS or single UL grant Type
2 scheduling release PDCCH validation when a UE is provided
a single SPS PDSCH or UL grant Type 2 configuration in
the active DL/UL BWP of the scheduled cell

| | DCI format | DCI format |
|---|---|---|
| | 0_0/0_1/0_2 | 1_0/1_1/1_2 |
| HARQ process number | set to all ‘0’s | set to all ‘0’s |
| Redundancy version | set to all ‘0’s | set to all ‘0’s |
| Modulation and coding | set to all ‘1’s | set to all ‘1’s |
| scheme | | |
| Frequency domain | set to all ‘0’s for | set to all ‘0’s for |
| resource assignment | FDRA Type 2 with | FDRA Type 0 or for |
| | μ = 1 | dynamicSwitch |
| | set to all ‘1’s, | set to all ‘1’s for |
| | otherwise | FDRA Type 1 |

TABLE 3
Special fields for a single DL SPS or single UL grant
Type 2 scheduling activation PDCCH validation when a
UE is provided multiple DL SPS or UL grant Type 2 configurations
in the active DL/UL BWP of the scheduled cell

| | DCI format | DCI format | DCI format |
|---|---|---|---|
| | 0_0/0_1/0_2 | 1_0/1_2 | 1_1 |
| Redundancy | set to all ‘0’s | set to all ‘0’s | For the enabled transport |
| version | | | block: set to all ‘0’s |

TABLE 4
Special fields for a single or multiple DL SPS and UL grant
Type 2 scheduling release PDCCH validation when a UE is
provided multiple DL SPS or UL grant Type 2 configurations
in the active DL/UL BWP of the scheduled cell

| | DCI format | DCI format |
|---|---|---|
| | 0_0/0_1/0_2 | 1_0/1_1/1_2 |
| Redundancy version | set to all ‘0’s | set to all ‘0’s |
| Modulation and | set to all ‘1’s | set to all ‘1’s |
| coding scheme | | |
| Frequency | set to all ‘0’s for | set to all ‘0’s for FDRA |
| domain resource | FDRA Type 2 with | Type 0 or for |
| assignment | μ = 1 | dynamicSwitch |
| | set to all ‘1’s, | set to all ‘1’s for FDRA |
| | otherwise | Type 1 |

In various embodiments, a UE is expected to provide HARQ acknowledgment (“ACK”) (“HARQ-ACK”) information in response to a SPS PDSCH release after N symbols from the last symbol of a PDCCH providing the SPS PDSCH release. If processing Type2Enabled of PDSCH-ServingCellConfig is set to enable for the serving cell with the PDCCH providing the SPS PDSCH release, N=5 for u=0, N=5.5 for u=1, and N=11 for u=2, otherwise, N=10 for μ=0, N=12 for μ=1, N=22 for μ=2, and N=25 for μ=3, wherein μ corresponds to the smallest subcarrier spacing (“SCS”) configuration between the SCS configuration of the PDCCH providing the SPS PDSCH release and the SCS configuration of a physical uplink control channel (“PUCCH”) carrying the HARQ-ACK information in response to a SPS PDSCH release.

In certain embodiments, there may be resource allocation for uplink transmission with configured grant.

When PUSCH resource allocation is semi-statically configured by higher layer parameter configuredGrantConfig in BWP-Uplink Dedicated information element (“IE”), and the PUSCH transmission corresponding to a configured grant, the following higher layer parameters are applied in the transmission:
1) for Type 1 PUSCH transmissions with a configured grant, the following parameters are given in configuredGrantConfig unless mentioned otherwise:
a) for the determination of the PUSCH repetition type, if the higher layer parameter pusch-RepTypeIndicator in rrc-ConfiguredUplinkGrant is configured and set to ‘pusch-RepTypeB’, PUSCH repetition type B is applied: otherwise, PUSCH repetition type A is applied;
b) for PUSCH repetition type A, the selection of the time domain resource allocation table follows the rules for DCI format 0_0 on UE specific search space;
c) for PUSCH repetition type B, the selection of the time domain resource allocation table is as follows:
c1) if pusch-RepTypeIndicatorDCI-0-1 in pusch-Config is configured and set to ‘pusch-RepTypeB’, pusch-Time Domain Resource AllocationListDCI-0-1 in pusch-Config is used;
c2) otherwise, pusch-TimeDomainResourceAllocationListDCI-0-2 in pusch-Config is used;
c3) it is not expected that pusch-RepTypeIndicator in rrc-ConfiguredUplinkGrant is configured with ‘pusch-RepTypeB’ when none of pusch-RepTypeIndicatorDCI-0-1 and pusch-RepTypeIndicatorDCI-0-2 in pusch-Config is set to ‘pusch-RepTypeB’;
d) the higher layer parameter time DomainAllocation value m provides a row index m+1 pointing to the determined time domain resource allocation table, where the start symbol and length are determined following the procedure;
e) frequency domain resource allocation is determined by the N least significant bit (“LSB”) bits in the higher layer parameter frequency DomainAllocation, forming a bit sequence f₁₇, . . . , f₁, f₀, where f₀ is the LSB, and N is determined as the size of frequency domain resource assignment field in DCI format 0_1 for a given resource allocation type indicated by resourceAllocation, except if useInterlacePUCCH-PUSCH in BWP-UplinkDedicated is configured, in which case uplink type 2 resource allocation is used wherein the UE interprets the LSB bits in the higher layer parameter frequency DomainAllocation as for the frequency domain resource assignment field of DCI 0_1;
f) the I_{MCS} is provided by higher layer parameter mcsAndTBS;
g) number of DM-RS code division multiplexing (“CDM”) groups, DM-RS ports, sounding reference signal (“SRS”) resource indication and DM-RS sequence initialization are determined, and the antenna port value, the bit value for DM-RS sequence initialization, precoding information and number of layers, SRS resource indicator are provided by antennaPort, dmrs-SeqInitialization, precodingAndNumberOfLayers, and srs-Resource Indicator respectively;
h) when frequency hopping is enabled, the frequency offset between two frequency hops can be configured by higher layer parameter frequency HoppingOffset; and
2) for Type 2 PUSCH transmissions with a configured grant: the resource allocation follows the higher layer configuration, and UL grant received on the DCI;
a) the PUSCH repetition type and the time domain resource allocation table are determined by the PUSCH repetition type and the time domain resource allocation table associated with the UL grant received on the DCI, respectively.

For PUSCH transmissions with a Type 1 or Type 2 configured grant, the number of (nominal) repetitions K to be applied to the transmitted transport block is provided by the indexed row in the time domain resource allocation table if numberOfRepetitions is present in the table: otherwise K is provided by the higher layer configured parameters repK.

The UE shall not transmit anything on the resources configured by configuredGrantConfig if the higher layers did not deliver a transport block to transmit on the resources allocated for uplink transmission without grant.

A set of allowed periodicities P are defined. The higher layer parameter cg-nrofSlots, provides the number of consecutive slots allocated within a configured grant period. The higher layer parameter cg-nrofPUSCH-InSlot provides the number of consecutive PUSCH allocations within a slot, where the first PUSCH allocation follows the higher layer parameter timeDomainAllocation for Type 1 PUSCH transmission or the higher layer configuration, and UL grant received on the DCI for Type 2 PUSCH transmissions, and the remaining PUSCH allocations have the same length and PUSCH mapping type, and are appended following the previous allocations without any gaps. The same combination of start symbol and length and PUSCH mapping type repeats over the consecutively allocated slots.

In certain embodiments, there may be a transport block repetition for uplink transmissions of PUSCH repetition Type A with a configured grant.

The procedures described in this clause apply to PUSCH transmissions of PUSCH repetition Type A with a Type 1 or Type 2 configured grant.

The higher layer parameter repK-RV defines the redundancy version pattern to be applied to the repetitions. If cg-Retransmission Timer is provided, the redundancy version for uplink transmission with a configured grant is determined by the UE. If the parameter repK-RV is not provided in the configuredGrantConfig and cg-RetransmissionTimer is not provided, the redundancy version for uplink transmissions with a configured grant shall be set to 0. If the parameter repK-RV is provided in the configuredGrantConfig and cg-Retransmission Timer is not provided, for the nth transmission occasion among K repetitions, n=1, 2, . . . , K, it is associated with (mod (n−1,4)+1) th value in the configured RV sequence. If a configured grant configuration is configured with startingFromRV0 set to ‘off’, the initial transmission of a transport block may only start at the first transmission occasion of the K repetitions. Otherwise, the initial transmission of a transport block may start at:
1) the first transmission occasion of the K repetitions if the configured RV sequence is {0,2,3,1},
2) any of the transmission occasions of the K repetitions that are associated with RV=0 if the configured RV sequence is {0,3,0,3}, and
3) any of the transmission occasions of the K repetitions if the configured RV sequence is {0,0,0,0}, except the last transmission occasion when K≥8.

For any RV sequence, the repetitions shall be terminated after transmitting K repetitions, or at the last transmission occasion among the K repetitions within the period P, or from the starting symbol of the repetition that overlaps with a PUSCH with the same HARQ process scheduled by DCI format 0_0, 0_1 or 0_2, whichever is reached first. In addition, the UE shall terminate the repetition of a transport block in a PUSCH transmission if the UE receives a DCI format 0_1 with DFI flag provided and set to ‘l’, and if in this DCI the UE detects ACK for the HARQ process corresponding to that transport block.

The UE is not expected to be configured with the time duration for the transmission of K repetitions larger than the time duration derived by the periodicity P. If the UE determines that, for a transmission occasion, the number of symbols available for the PUSCH transmission in a slot is smaller than transmission duration L, the UE does not transmit the PUSCH in the transmission occasion.

For both Type 1 and Type 2 PUSCH transmissions with a configured grant, when K>1, the UE shall repeat the TB across the K consecutive slots applying the same symbol allocation in each slot, except if the UE is provided with higher layer parameters cg-nrofSlots and cg-nrofPUSCH-InSlot, in which case the UE repeats the TB in the repK earliest consecutive transmission occasion candidates within the same configuration. A Type 1 or Type 2 PUSCH transmission with a configured grant in a slot is omitted according to conditions.

In various embodiments, there may be transport block repetition for uplink transmissions of PUSCH repetition Type B with a configured grant.

The procedures described herein apply to PUSCH transmissions of PUSCH repetition type B with a Type 1 or Type 2 configured grant.

For PUSCH transmissions with a Type 1 or Type 2 configured grant, the nominal repetitions and the actual repetitions are determined according to the procedures for PUSCH repetition Type B. The higher layer configured parameters repK-RV defines the redundancy version pattern to be applied to the repetitions. If the parameter repK-RV is not provided in the configuredGrantConfig, the redundancy version for each actual repetition with a configured grant shall be set to 0. Otherwise, for the nth transmission occasion among all the actual repetitions (including the actual repetitions that are omitted) of the K nominal repetitions, it is associated with (mod (n−1,4)+1) th value in the configured RV sequence. If a configured grant configuration is configured with starting FromRV0 set to ‘off’, the initial transmission of a transport block may only start at the first transmission occasion of the actual repetitions. Otherwise, the initial transmission of a transport block may start at:
1) the first transmission occasion of the actual repetitions if the configured RV sequence is {0,2,3,1},
2) any of the transmission occasions of the actual repetitions that are associated with RV=0 if the configured RV sequence is {0,3,0,3}, and
3) any of the transmission occasions of the actual repetitions if the configured RV sequence is {0,0,0,0}, except the actual repetitions within the last nominal repetition when K≥8.

For any RV sequence, the repetitions shall be terminated after transmitting K nominal repetitions, or at the last transmission occasion among the K nominal repetitions within the period P, or from the starting symbol of a repetition that overlaps with a PUSCH with the same HARQ process scheduled by DCI format 0_0, 0_1 or 0_2, whichever is reached first. The UE is not expected to be configured with the time duration for the transmission of K nominal repetitions larger than the time duration derived by the periodicity P.

In a first embodiment, there may be enhanced DL semi-persistent scheduling (“SPS”) and UL configured grant (“CG”) operation for capacity enhancement.

In one embodiment, a UE receives information of one or more sets of UL CG (or DL SPS) configurations, where each set of UL CG (or DL SPS) configurations includes one or more UL CG and/or DL SPS (“UL CG/DL SPS”) configurations, and where each UL CG/DL SPS configuration includes independent UL grant and/or DL assignment information such as time and frequency-domain resource allocations, MCS, and other PUSCH and/or PDSCH-specific scheduling information (e.g., a PUCCH resource and HARQ-ACK feedback delay for SPS PDSCH HARQ-ACK feedback), precoding information and number of layers, an antenna port value, an SRS resource indicator, frequency offset between two frequency hops (if frequency hopping is enabled), and/or a bit value for DM-RS sequence initialization, in addition to scheduling periodicity and a number of HARQ processes. Further, the UE detects a DCI format that indicates scheduling activation of a (e.g., at least one) set of UL CG/DL SPS configurations (e.g., from the one or more sets of configured UL CG/DL SPS configurations) for a configured or dynamically indicated duration. In response to detecting the DCI format, the UE, for the indicated duration, transmits/receives CG PUSCH/SPS PDSCH on one or more CG PUSCH/SPS PDSCH occasions of the activated set of UL CG/DL SPS configurations. The DCI format may include additional scheduling information such as a cyclic shift value applied to allocated (e.g., virtual) resource block indices and/or an offset value applied to allocated symbol indices for each UL CG/DL SPS configuration of the activated set, from which the UE can dynamically determine time and frequency-resources actually allocated for the activated set. That is, actual time and frequency-resources to be used may vary in every activation. In some examples, the UE expects the configured or dynamically indicated duration to be at least (e.g., greater than or equal to) the minimum of the periodicities configured for the one or more UL CG/DL SPS configurations of the set of UL CG/DL SPS configurations.

In some examples, the activation of the UL CG/DL SPS in the set of UL CG/DL SPS configurations are valid until the UE receives a valid deactivation/release of the UL CG/DL SPS or the set of UL CG/DL SPS configurations, and in this case the validity/activation duration may not be configured or dynamically indicated. In various examples, the validity/activation duration may be identified based on receiving a valid release message. The valid release message may be a scheduling release PDCCH, with a value of the HARQ process number field in scheduling release DCI format indicating a release for UL CG/DL SPS in the set of UL CG/DL SPS configurations. In an example, a UE validates the scheduling activation/scheduling release by checking whether certain DCI fields have certain values and/or whether the CRC of the corresponding DCI format is scrambled with a certain RNTI, and/or whether the PDSCH-to-HARQ_feedback timing indicator field in the DCI provides an inapplicable value from a list of configured values (e.g., the parameter dl-DataToUL-ACK-r16).

In one example, a UE validates the scheduling activation of a set of DL SPS configurations if the PDSCH-to-HARQ_feedback timing indicator field in DL DCI provides an inapplicable value from a list of feedback delay values (dl-DataToUL-ACK-r16) configured in a corresponding active UL BWP together with the modulation and coding scheme field setting to all ‘1’s and the redundancy version field setting to all ‘0’s in the DL DCI.

In another example, a UE determines HARQ-ACK transmission occasions in response to SPS PDSCHs of an activated set of DL SPS configurations based on the PDSCH-to-HARQ_feedback timing indicator field in DL DCI and validates the scheduling activation of the set of DL SPS configurations if the PDSCH-to-HARQ_feedback timing indicator field in the DL DCI does not provide an inapplicable value from a list of feedback delay values (dl-DataToUL-ACK-r16). In one implementation, the feedback delay indicated in the PDSCH-to-HARQ_feedback timing indicator field in the DL DCI is associated with a reference SPS configuration index of the set of SPS configurations activated for scheduling.

In certain examples, the UE validates the scheduling activation only if a duration of activation is longer than a threshold. In an example, the duration of activation might be a maximum configured value for activation duration.

In some examples, a set of possible activation duration is configured via radio resource control (“RRC”) signaling, and the DCI indicates a value from the set of configured activation durations. In one example, the minimum activation duration is larger than a threshold (e.g., ‘x’ CG/SPS occasions where ‘x″>1), and the maximum activation duration is smaller than another threshold (e.g., y’ CG/SPS occasions where ‘y’ can be determined based on a UE capability reporting or based on a traffic rate (such as frame per second (“FPS”))).

In one implementation, CG PUSCHs/SPS PDSCHs of different UL CG/DL SPS configurations in an activated set of UL CG/DL SPS configurations of a UE carry independent and/or different TBs (e.g., transport blocks associated with a first UL CG/DL SPS configuration in an activated set of UL CG/DL SPS configurations are transmitted only on transmission occasions corresponding to the with a first UL CG/DL SPS configuration, and transport blocks associated with a second UL CG/DL SPS configuration in an activated set of UL CG/DL SPS configurations are transmitted only on transmission occasions corresponding to the with the second UL CG/DL SPS configuration). Further, the different UL CG/DL SPS configurations in the activated set may have different target block error rates (“BLERs”) and/or different target latencies. Each DL SPS configuration may have an independently configured HARQ-ACK codebook index (e.g., an independently configured HARQ-ACK priority), and each UL CG configuration may have an independently configured physical layer priority index. For example, the UE transmits most of data from an auxiliary sensor on UL CG resources of a lower priority index, while transmitting video packets from a video camera on UL CG resources of a higher priority index. In various embodiments, the UE may expect that all UL CG/DL SPS configurations in the activated set may be configured or dynamically indicated (e.g., via an activation DCI) with the same physical layer priority index and/or HARQ-ACK codebook index, where the priority may be dependent on an application triggering activation of the UL CG/DL SPS set.

In another implementation, DL SPS is a type1 DL SPS, where a DL assignment is provided by PDCCH, and stored or cleared based on L1 signaling indicating SPS activation or deactivation/release. In some embodiments, type2 DL SPS may be specified such that a DL assignment is configured by RRC and the configured DL assignment is stored for a certain duration (e.g., duration corresponding to a number of SPS occasions or a number of SPS periods) and then cleared, based on L1 signaling indicating SPS activation or deactivation/release only for a certain duration. RRC may configure the following parameters in addition to other SPS configuration parameters when the type2 DL SPS is configured:
1) frequencyDomainResourceAssignment—frequency domain resource assignment, number of bits determined by the following, where N_{RB}^{DL,BWP} is the size of the active DL bandwidth part:
a) N_{RBG} bits if only resource allocation type 0 is configured, where N_{RBG} is defined.
b) ┌log₂(N_{RB}^{DL,BWP}(N_{RB}^{DL,BWP}+1)/2)┐ bits if only resource allocation type 1 is configured,
c) max (┌log₂(N_{RB}^{DL,BWP}(N_{RB}^{DL,BWP}+1)/2)┐, N_{RBG})+1 RBG bits if resourceAllocation is configured as ‘dynamicSwitch’,
d) if resourceAllocation is configured as ‘dynamicSwitch’, the most significant bit (“MSB”) bit is used to indicate resource allocation type 0 or resource allocation type 1, where the bit value of 0 indicates resource allocation type 0 and the bit value of 1 indicates resource allocation type 1,
e) for resource allocation type 0, the N_{RBG} LSBs provide the resource allocation,
f) for resource allocation type 1, the ┌log₂(N_{RB}^{DL,BWP}(N_{RB}^{DL,BWP}+1)/2)┐ LSBs provide the resource allocation;
2) timeDomainResourceAssignment—time domain resource assignment, 4 bits;
3) antennaPort—4, 5, or 6 bits—the antenna ports {p₀, . . . , pᵥ₋₁} may be determined according to an ordering of demodulation reference signal (“DMRS” or “DM-RS”) port(s);
5) dmrsSeqInitialization—a value used for DMRS sequence initialization;
6) vrbToPRB—virtual resource block (“VRB”)-to-physical resource block (“PRB”) mapping, 1 bit;
7) mcsAndTBS—a modulation and coding scheme, 5 bits; and
8) dlDataToHARQDelay—a PDSCH-to-HARQ_feedback delay value.

In some embodiments, a DCI format with CRC scrambled by CS-RNTI, which indicates type2 DL SPS activation for an indicated duration may include the following bit fields:
1) identifier for DCI formats—indicating a DL or UL DCI format;
2) carrier indicator—cross-carrier activation, if configured;
3) bandwidth part indicator—cross-bandwidth part activation, if configured;
4) rate matching indicator—0, 1, or 2 bits according to higher layer parameters rateMatchPatternGroup1 and rateMatchPatternGroup2, where the MSB is used to indicate rateMatchPatternGroup1 and the LSB is used to indicate rateMatchPatternGroup2 when there are two groups;
5) zero power (“ZP”) CSI-RS trigger—0, 1, or 2 bits—the bitwidth for this field is determined as ┌log₂(n_{ZP}+1)┐ bits, where n_{ZP} is the number of aperiodic ZP CSI-RS resource sets configured by higher layer;
6) frequency domain resource offset indicator (reusing the frequency domain resource assignment field)—indicating a set of cyclic shift values, where a first value is applied to allocated resource block (“RB”) indices of a DL SPS configuration with the lowest configuration index, a second value is applied to allocated RB indicates of a DL SPS configuration with the second lowest configuration index, and so on. In one example, a first value is applied to allocated RB indices of a DL SPS configuration with the second lowest configuration index, a second value is applied to allocated RB indicates of a DL SPS configuration with the third lowest configuration index, and so on. No offset is applied to allocated RB indices of a DL SPS configuration with the lowest configuration index.
7) time domain resource offset indicator (e.g., reusing the time domain resource assignment field)—indicating a set of shift values, where a first value is applied to allocated symbol indices of a DL SPS configuration with the lowest configuration index, a second value is applied to allocated symbol indices of a DL SPS configuration with the second lowest configuration index, and so on. In another example, a first value is applied to allocated symbol indices of a DL SPS configuration with the second lowest configuration index, a second value is applied to allocated symbol indicates of a DL SPS configuration with the third lowest configuration index, and so on. No offset is applied to allocated symbol indices of a DL SPS configuration with the lowest configuration index.
8) active time duration indicator—indicating an active time duration for an activated set of DL SPS configurations. A UE considers that SPS PDSCH occasions within a time window of the indicated duration, the time window starting from a slot where the first SPS PDSCH occasion occurs upon activation, are active;
9) priority indicator—priority indication for all DL SPS configurations in an activated set of DL SPS configurations;
10) new data indicator—setting to ‘0’;
11) modulation and coding scheme—setting to all ‘1’s to validate the type2 DL SPS activation;
12) redundancy version—setting to all ‘0’s to validate the type2 DL SPS activation;
13) HARQ process number—if a UE is provided sps-ConfigActivationStateList, a value of the HARQ process number field in a DCI format indicates a corresponding entry for scheduling activation of one or more type 2 DL SPS configurations; and
14) the remaining bits in the DCI format are reserved (note: A size of the DCI format is determined based on RRC parameter configuration).

In various embodiments, after receiving an activation DCI, a MAC entity of a UE may consider sequentially that the Nth downlink assignment of an activated DL SPS configuration occurs in a slot for which:

$$( numberOfSLotsPerFrame \times subframe number ( “ SFN ” ) + slot number in the frame ) = [ ( numberOfSlotsPerFrame \times SFNstart time + slotstart time ) + N \times periodicity \times numberOfSlotsPerFrame / 10 ] modulo ( 1024 \times numberOfSlotsPerFrame ) ,$$

where SFNstart time and slotstart time are the SFN and slot, respectively, of the first transmission of SPS PDSCH upon the activation of the DL SPS configuration.

In one implementation, a UE does not transmit an acknowledgement to a network entity in response to detecting a DCI format indicating an activation of a set of DL SPS configurations for a certain duration. The network entity may assume that the UE has identified active SPS PDSCH occasions correctly by receiving HARQ-ACK feedback for the active SPS PDSCH occasions. The UE can save power by not transmitting the acknowledgement.

In another implementation, for type 3 UL CG, an uplink grant is provided by RRC, and is stored for a certain duration (e.g., duration corresponding to a number of CG occasions or a number of CG periods) and then cleared based on L1 signaling indicating CG activation or deactivation/release only for a certain duration. A type 3 UL CG configuration does not include parameters time DomainOffset and timeReferenceSFN. Instead, after receiving an activation DCI, a MAC entity of a UE shall consider sequentially that the N^{th} (N>=0) uplink grant of an activated UL CG configuration occurs in a symbol for which:

$$[ ( SFN \times numberOfSlotsPerFrame \times numberOfSymbolsPerSlot ) + ( slot number in the frame \times numberOfSymbolsPerSlot ) + symbol number in the slot ] = [ ( SFNstart time \times numberOfSlotsPerFrame \times numberOfSymbolsPerSlot + slotstart time \times numberOfSymbolsPerSlot + symbolstart time ) + N \times periodicity ] modulo ( 1024 \times numberOfSlotsPerFrame \times numberOfSymbolsPerSlot ) ,$$

where SFNstart time, slotstart time, and symbolstart time are the SFN, slot, and symbol, respectively, of the first transmission opportunity of CG PUSCH upon the activation of the UL CG configuration.

In certain embodiments, a DCI format with CRC scrambled by CS-RNTI, which indicates type3 UL CG activation for an indicated duration, may include the following bit fields:
1) identifier for DCI formats—indicating a DL or UL DCI format;
2) carrier indicator—cross-carrier activation, if configured;
3) bandwidth part indicator—cross-bandwidth part activation, if configured;
4) invalid symbol pattern indicator—0 bit if higher layer parameter invalidSymbolPatternIndicatorDCI-0-1 is not configured: otherwise 1 bit;
5) frequency domain resource offset indicator (e.g., reusing the frequency domain resource assignment field)—indicating a set of cyclic shift values, where a first value is applied to allocated RB indices of a UL CG configuration with the lowest configuration index, a second value is applied to allocated RB indicates of a UL CG configuration with the second lowest configuration index, and so on. In another example, a first value is applied to allocated RB indices of a UL CG configuration with the second lowest configuration index, a second value is applied to allocated RB indicates of a UL CG configuration with the third lowest configuration index, and so on. No offset is applied to allocated RB indices of a UL CG configuration with the lowest configuration index;
6) time domain resource offset indicator (e.g., reusing the time domain resource assignment field)—indicating a set of shift values, where a first value is applied to allocated symbol indices of a UL CG configuration with the lowest configuration index, a second value is applied to allocated symbol indices of a UL CG configuration with the second lowest configuration index, and so on. In another example, a first value is applied to allocated symbol indices of a UL CG configuration with the second lowest configuration index, a second value is applied to allocated symbol indicates of a UL CG configuration with the third lowest configuration index, and so on. No offset is applied to allocated symbol indices of a UL CG configuration with the lowest configuration index;
7) active time duration indicator—indicating an active time duration for an activated set of UL CG configurations. A UE considers that CG PUSCH occasions within a time window of the indicated duration, the time window starting from a slot where the first UL PUSCH occasion occurs upon activation, are active;
8) priority indicator—priority indication for all DL SPS configurations in an activated set of DL SPS configurations;
9) new data indicator—setting to ‘0’;
10) modulation and coding scheme—setting to all ‘1’s to validate the type2 DL SPS activation;
11) redundancy version-setting to all ‘0’s to validate the type2 DL SPS activation;
12) HARQ process number—if a UE is provided ConfiguredGrantConfig Type3ActivationStateList, a value of the HARQ process number field in a DCI format indicates a corresponding entry for scheduling activation of one or more Type 3 UL CG configurations; and
13) the remaining bits in the DCI format are reserved (e.g., a size of the DCI format is determined based on RRC parameter configuration).

In one implementation, a UE transmits an acknowledgement/confirmation to a network entity, upon detection of a DCI format indicating an activation of a set of UL CG configurations for a certain duration. The acknowledgement transmission would ensure that the UE and the network entity have the same understanding for one or more active CG PUSCH transmission occasions. In one example, the activation DCI includes a PUCCH resource indicator and an ACK feedback delay indicator, from which the UE can identify a PUCCH transmission occasion for the acknowledge transmission. In another example, the acknowledgement information is multiplexed as part of configured grant (“CG”)-uplink control information (“UCI”) in CG PUSCH. In yet another example, a MAC of the UE generates a joint configured grant confirmation MAC CE upon detecting the activation DCI and transmits the generated MAC CE in a PUSCH resource allocated for a new transmission. For example, the joint configured grant confirmation MAC CE is defined as follows:
1) CGSi: this field indicates whether PDCCH indicating activation of a set of configured uplink grants with ConfiguredGrantConfig Type3ActivationStateMAC i has been received. The CGSi field is set to 1 to indicate that PDCCH indicating activation of type 3 configured uplink grants with ConfiguredGrantConfig Type3ActivationStateMAC i has been received and type 3 configured uplink grants of ConfiguredGrantConfig Type3ActivationStateMAC i are active. The CGSi field is set to 0 to indicate that type 3 configured uplink grants of ConfiguredGrantConfig Type3ActivationStateMAC i are inactive.

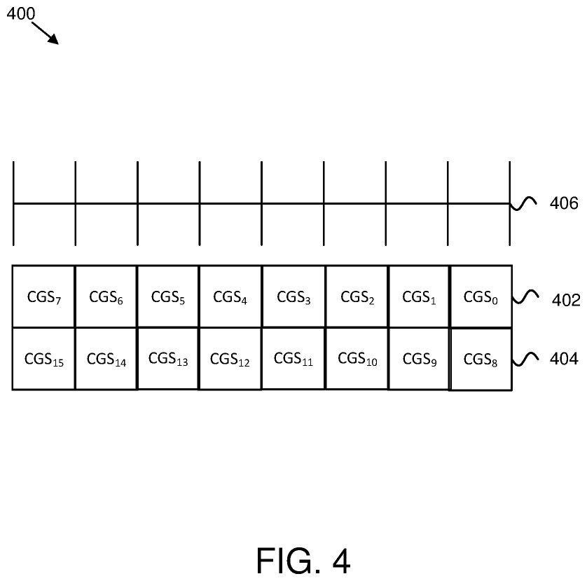

FIG. 4 is a schematic block diagram illustrating one embodiment of a joint configured grant confirmation MAC CE 400. The MAC CE 400 includes a first octet 402 and a second octet 404, each having 8 bits 406.

In some embodiments, when the acknowledgement UCI or confirmation MAC CE is transmitted in one of activated CG PUSCHs, the UE may send the acknowledgement UCI or confirmation MAC CE on an activated CG PUSCH with the earliest starting symbol.

In various embodiments, upon receiving a type 3 UL CG activation DCI, the UE stops a configuredGrantTimer for a corresponding HARQ process, if running. Also, the UE stops a cg-Retransmission Timer for a corresponding HARQ process, if running.

In a second embodiment, there may be enhanced HARQ-ACK feedback for bounded latency requirement for XR.

In one embodiment, a UE identifies the maximum latency of a given DL TB based on internal interaction with its application layer and transmits retransmission related control information (“RCI”) along with HARQ-ACK information in a PUCCH resource (or in a PUSCH resource if uplink control information UCI including RCI is multiplexed in PUSCH). In one example, RCI includes information of a remaining valid duration for retransmission of the TB, with respect to a current (or most recent) PDSCH occasion for the TB or, in another example, with respect to the transmission occasion comprising the RCI. In a further example, RCI includes a request of no further retransmission of the TB.

In one implementation, a UE receives an indication of RCI transmission request in DCI scheduling a unicast PDSCH, where the DCI is detected in a UE-specific search space (e.g., DCI with CRC scrambled with C-RNTI, MCS-C-RNTI, or CS-RNTI).

In another embodiment, a UE identifies the maximum latency of a given UL TB based on internal interaction with its application layer and transmits RCI (e.g., information of a remaining valid duration for retransmission of the TB (e.g., with respect to a current (or most recent) PUSCH occasion for the TB or, in another example, with respect to the transmission occasion comprising the RCI), a request of no further retransmission of the TB) in a PUSCH carrying the UL TB. In one example, the request of no further retransmission of the TB is sent as part of UCI multiplexed in a PUSCH resource, when DCI scheduling the PUSCH resource includes an indication of RCI transmission request. In another example, the RCI transmission is configured for UL data of a particular logical channel, as part of a logical channel configuration. The UE docs not expect to receive DCI indicating a RCI transmission along with retransmission of UL data of a logical channel that is not configured with the RCI transmission.

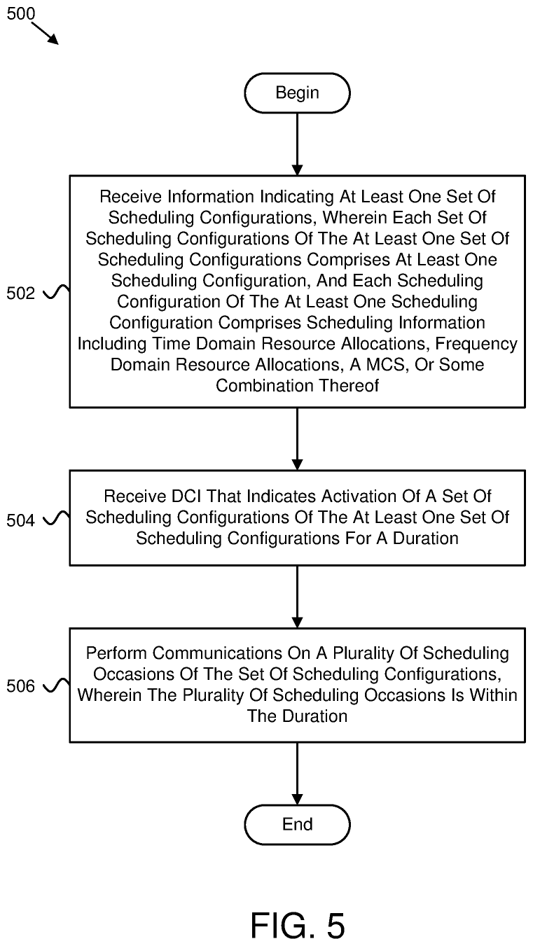

FIG. 5 is a flow chart diagram illustrating one embodiment of a method 500 for performing communications using a set of scheduling configurations. In some embodiments, the method 500 is performed by an apparatus, such as the remote unit 102. In certain embodiments, the method 500 may be performed by a processor executing program code, for example, a microcontroller, a microprocessor, a CPU, a GPU, an auxiliary processing unit, a FPGA, or the like.

In various embodiments, the method 500 includes receiving 502 information indicating at least one set of scheduling configurations. Each set of scheduling configurations of the at least one set of scheduling configurations includes at least one scheduling configuration, and each scheduling configuration of the at least one scheduling configuration includes scheduling information including time domain resource allocations, frequency domain resource allocations, a MCS, or some combination thereof. In some embodiments, the method 500 includes receiving 504 DCI that indicates activation of a set of scheduling configurations of the at least one set of scheduling configurations for a duration. In certain embodiments, the method 500 includes performing 506 communications on a plurality of scheduling occasions of the set of scheduling configurations. The plurality of scheduling occasions is within the duration.

In certain embodiments, the DCI comprises at least one resource offset value applied to the time domain resource allocations and the frequency domain resource allocations. In some embodiments, the DCI comprises information indicating an MCS index offset for a scheduling configuration of the set of scheduling configurations, and wherein performing the communications comprises performing the communications based on an MCS indicated in the scheduling configuration and the MCS index offset. In various embodiments, the DCI comprises information indicating the duration.

In one embodiment, the DCI comprises an indication of a first priority of the plurality of scheduling occasions, an indication of the first priority related to communications on the plurality of scheduling occasions, or a combination thereof. In certain embodiments, the communications on the plurality of scheduling occasions comprise a plurality of SPS PDSCHs, and the first priority comprises a second priority of HARQ-ACK information corresponding to the plurality of SPS PDSCHs. In some embodiments, each scheduling configuration of the at least one scheduling configuration comprises an uplink CG configuration, and the plurality of scheduling occasions comprise a plurality of CG PUSCH occasions.

In various embodiments, the method 500 further comprises transmitting an acknowledgement upon receiving the DCI on a CG PUSCH occasion of the plurality of CG PUSCH occasions, wherein the CG PUSCH occasion has an earliest starting symbol among the plurality of CG PUSCH occasions. In one embodiment, the acknowledgement comprises a joint activation confirmation MAC CE indicating whether a DCI format indicating activation of a set of configured uplink grant configurations has been detected. In certain embodiments, the DCI format comprises a cyclic shift value, an offset value, or a combination thereof.

In some embodiments, the duration comprises a configured duration or a dynamically indicated duration. In various embodiments, the duration is selected from a set of possible activation durations. In one embodiment, the set of possible activation durations is configured via RRC signaling.

In certain embodiments, the DCI indicates a value from the set of possible activation durations, and the value corresponds to the duration. In some embodiments, each scheduling configuration of the at least one scheduling configuration comprises an independent TB, a different TB, or a combination thereof. In various embodiments, each scheduling configuration of the at least one scheduling configuration comprises an independently configured HARQ-ACK codebook index, an independently configured physical layer priority index, or a combination thereof.

In one embodiment, each scheduling configuration of the at least one scheduling configuration comprises a same HARQ-ACK codebook index, a same configured physical layer priority index, or a combination thereof. In certain embodiments, the method 500 further comprises not performing communications on the plurality of scheduling occasions for a second duration after the duration. In some embodiments, the method 500 further comprises transmitting retransmission related control information, wherein the retransmission related control information comprises information of a remaining valid duration for retransmission of a TB, an indication of no further transmission of the TB, or a combination thereof.

In various embodiments, the retransmission related control information is transmitted together with HARQ-ACK information. In one embodiment, the retransmission related control information is transmitted together with the TB. In certain embodiments, the method 500 further comprises receiving a logical channel configuration, wherein the logical channel configuration comprises a request for transmission of the retransmission related control information, and the TB comprises uplink data associated with the logical channel configuration.

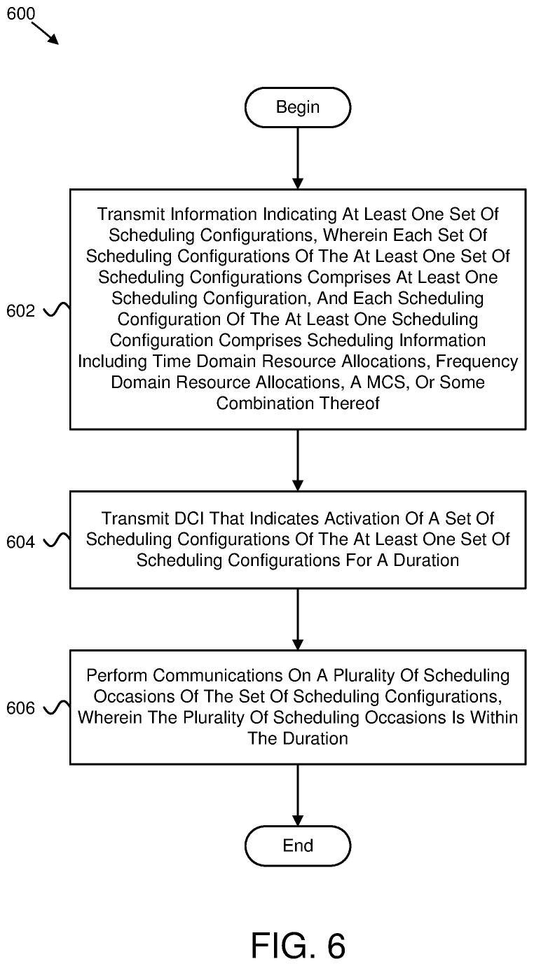

FIG. 6 is a flow chart diagram illustrating another embodiment of a method 600 for performing communications using a set of scheduling configurations. In some embodiments, the method 600 is performed by an apparatus, such as the network unit 104. In certain embodiments, the method 600 may be performed by a processor executing program code, for example, a microcontroller, a microprocessor, a CPU, a GPU, an auxiliary processing unit, a FPGA, or the like.

In various embodiments, the method 600 includes transmitting 602 information indicating at least one set of scheduling configurations, wherein each set of scheduling configurations of the at least one set of scheduling configurations includes at least one scheduling configuration, and each scheduling configuration of the at least one scheduling configuration includes scheduling information including time domain resource allocations, frequency domain resource allocations, a MCS, or some combination thereof. In some embodiments, the method 600 includes transmitting 604 DCI that indicates activation of a set of scheduling configurations of the at least one set of scheduling configurations for a duration. In certain embodiments, the method 600 includes performing 606 communications on a plurality of scheduling occasions of the set of scheduling configurations. The plurality of scheduling occasions is within the duration.

In certain embodiments, the DCI comprises at least one resource offset value applied to the time domain resource allocations and the frequency domain resource allocations. In some embodiments, the DCI comprises information indicating an MCS index offset for a scheduling configuration of the set of scheduling configurations, and wherein performing the communications comprises performing the communications based on an MCS indicated in the scheduling configuration and the MCS index offset. In various embodiments, the DCI comprises information indicating the duration.

In one embodiment, the DCI comprises an indication of a first priority of the plurality of scheduling occasions, an indication of the first priority related to communications on the plurality of scheduling occasions, or a combination thereof. In certain embodiments, the communications on the plurality of scheduling occasions comprise a plurality of SPS PDSCHs, and the first priority comprises a second priority of HARQ-ACK information corresponding to the plurality of SPS PDSCHs. In some embodiments, each scheduling configuration of the at least one scheduling configuration comprises an uplink CG configuration, and the plurality of scheduling occasions comprise a plurality of CG PUSCH occasions.

In various embodiments, the method 600 further comprises receiving an acknowledgement, upon transmitting the DCI, on a CG PUSCH occasion of the plurality of CG PUSCH occasions, wherein the CG PUSCH occasion has an earliest starting symbol among the plurality of CG PUSCH occasions. In one embodiment, the acknowledgement comprises a joint activation confirmation MAC CE indicating whether a DCI format indicating activation of a set of configured uplink grant configurations has been detected. In certain embodiments, the DCI format comprises a cyclic shift value, an offset value, or a combination thereof.

In some embodiments, the duration comprises a configured duration or a dynamically indicated duration. In various embodiments, the duration is selected from a set of possible activation durations. In one embodiment, the set of possible activation durations is configured via RRC signaling.

In certain embodiments, the DCI indicates a value from the set of possible activation durations, and the value corresponds to the duration. In some embodiments, each scheduling configuration of the at least one scheduling configuration comprises an independent TB, a different TB, or a combination thereof. In various embodiments, each scheduling configuration of the at least one scheduling configuration comprises an independently configured HARQ-ACK codebook index, an independently configured physical layer priority index, or a combination thereof.

In one embodiment, each scheduling configuration of the at least one scheduling configuration comprises a same HARQ-ACK codebook index, a same configured physical layer priority index, or a combination thereof. In certain embodiments, the method 600 further comprises not performing communications on the plurality of scheduling occasions for a second duration after the duration. In some embodiments, the method 600 further comprises receiving retransmission related control information, wherein the retransmission related control information comprises information of a remaining valid duration for retransmission of a TB, an indication of no further transmission of the TB, or a combination thereof.

In various embodiments, the retransmission related control information is transmitted together with HARQ-ACK information. In one embodiment, the retransmission related control information is transmitted together with the TB. In certain embodiments, the method 600 further comprises transmitting a logical channel configuration, wherein the logical channel configuration comprises a request for transmission of the retransmission related control information, and the TB comprises uplink data associated with the logical channel configuration.

In one embodiment, an apparatus comprises: a transceiver to: receive information indicating at least one set of scheduling configurations, wherein each set of scheduling configurations of the at least one set of scheduling configurations comprises at least one scheduling configuration, and each scheduling configuration of the at least one scheduling configuration comprises scheduling information including time domain resource allocations, frequency domain resource allocations, a MCS, or some combination thereof: receive DCI that indicates activation of a set of scheduling configurations of the at least one set of scheduling configurations for a duration; and perform communications on a plurality of scheduling occasions of the set of scheduling configurations, wherein the plurality of scheduling occasions is within the duration.

In certain embodiments, the DCI comprises at least one resource offset value applied to the time domain resource allocations and the frequency domain resource allocations.

In some embodiments, the DCI comprises information indicating an MCS index offset for a scheduling configuration of the set of scheduling configurations, and wherein performing the communications comprises performing the communications based on an MCS indicated in the scheduling configuration and the MCS index offset.

In various embodiments, the DCI comprises information indicating the duration.

In one embodiment, the DCI comprises an indication of a first priority of the plurality of scheduling occasions, an indication of the first priority related to communications on the plurality of scheduling occasions, or a combination thereof.

In certain embodiments, the communications on the plurality of scheduling occasions comprise a plurality of SPS PDSCHs, and the first priority comprises a second priority of HARQ-ACK information corresponding to the plurality of SPS PDSCHs.

In some embodiments, each scheduling configuration of the at least one scheduling configuration comprises an uplink CG configuration, and the plurality of scheduling occasions comprise a plurality of CG PUSCH occasions.

In various embodiments, the transceiver further to transmit an acknowledgement upon receiving the DCI on a CG PUSCH occasion of the plurality of CG PUSCH occasions, wherein the CG PUSCH occasion has an earliest starting symbol among the plurality of CG PUSCH occasions.

In one embodiment, the acknowledgement comprises a joint activation confirmation MAC CE indicating whether a DCI format indicating activation of a set of configured uplink grant configurations has been detected.

In certain embodiments, the DCI format comprises a cyclic shift value, an offset value, or a combination thereof.

In some embodiments, the duration comprises a configured duration or a dynamically indicated duration.

In various embodiments, the duration is selected from a set of possible activation durations.

In one embodiment, the set of possible activation durations is configured via RRC signaling.

In certain embodiments, the DCI indicates a value from the set of possible activation durations, and the value corresponds to the duration.

In some embodiments, each scheduling configuration of the at least one scheduling configuration comprises an independent TB, a different TB, or a combination thereof.

In various embodiments, each scheduling configuration of the at least one scheduling configuration comprises an independently configured HARQ-ACK codebook index, an independently configured physical layer priority index, or a combination thereof.

In one embodiment, each scheduling configuration of the at least one scheduling configuration comprises a same HARQ-ACK codebook index, a same configured physical layer priority index, or a combination thereof.

In certain embodiments, the transceiver further to not perform communications on the plurality of scheduling occasions for a second duration after the duration.

In some embodiments, the transceiver further to transmit retransmission related control information, and the retransmission related control information comprises information of a remaining valid duration for retransmission of a TB, an indication of no further transmission of the TB, or a combination thereof.

In various embodiments, the retransmission related control information is transmitted together with HARQ-ACK information.

In one embodiment, the retransmission related control information is transmitted together with the TB.

In certain embodiments, the transceiver further to receive a logical channel configuration, wherein the logical channel configuration comprises a request for transmission of the retransmission related control information, and the TB comprises uplink data associated with the logical channel configuration.

In one embodiment, a method at a UE, the method comprises: receiving information indicating at least one set of scheduling configurations, wherein each set of scheduling configurations of the at least one set of scheduling configurations comprises at least one scheduling configuration, and each scheduling configuration of the at least one scheduling configuration comprises scheduling information including time domain resource allocations, frequency domain resource allocations, a MCS, or some combination thereof: receiving DCI that indicates activation of a set of scheduling configurations of the at least one set of scheduling configurations for a duration; and performing communications on a plurality of scheduling occasions of the set of scheduling configurations, wherein the plurality of scheduling occasions is within the duration.

In certain embodiments, the DCI comprises at least one resource offset value applied to the time domain resource allocations and the frequency domain resource allocations.

In some embodiments, the DCI comprises information indicating an MCS index offset for a scheduling configuration of the set of scheduling configurations, and wherein performing the communications comprises performing the communications based on an MCS indicated in the scheduling configuration and the MCS index offset.

In various embodiments, the DCI comprises information indicating the duration.

In one embodiment, the DCI comprises an indication of a first priority of the plurality of scheduling occasions, an indication of the first priority related to communications on the plurality of scheduling occasions, or a combination thereof.

In certain embodiments, the communications on the plurality of scheduling occasions comprise a plurality of SPS PDSCHs, and the first priority comprises a second priority of HARQ-ACK information corresponding to the plurality of SPS PDSCHs.

In some embodiments, each scheduling configuration of the at least one scheduling configuration comprises an uplink CG configuration, and the plurality of scheduling occasions comprise a plurality of CG PUSCH occasions.

In various embodiments, the method further comprises transmitting an acknowledgement upon receiving the DCI on a CG PUSCH occasion of the plurality of CG PUSCH occasions, wherein the CG PUSCH occasion has an earliest starting symbol among the plurality of CG PUSCH occasions.

In one embodiment, the acknowledgement comprises a joint activation confirmation MAC CE indicating whether a DCI format indicating activation of a set of configured uplink grant configurations has been detected.

In certain embodiments, the DCI format comprises a cyclic shift value, an offset value, or a combination thereof.

In some embodiments, the duration comprises a configured duration or a dynamically indicated duration.

In various embodiments, the duration is selected from a set of possible activation durations.

In one embodiment, the set of possible activation durations is configured via RRC signaling.

In certain embodiments, the DCI indicates a value from the set of possible activation durations, and the value corresponds to the duration.

In some embodiments, each scheduling configuration of the at least one scheduling configuration comprises an independent TB, a different TB, or a combination thereof.

In various embodiments, each scheduling configuration of the at least one scheduling configuration comprises an independently configured HARQ-ACK codebook index, an independently configured physical layer priority index, or a combination thereof.

In one embodiment, each scheduling configuration of the at least one scheduling configuration comprises a same HARQ-ACK codebook index, a same configured physical layer priority index, or a combination thereof.

In certain embodiments, the method further comprises not performing communications on the plurality of scheduling occasions for a second duration after the duration.

In some embodiments, the method further comprises transmitting retransmission related control information, wherein the retransmission related control information comprises information of a remaining valid duration for retransmission of a TB, an indication of no further transmission of the TB, or a combination thereof.

In various embodiments, the retransmission related control information is transmitted together with HARQ-ACK information.

In one embodiment, the retransmission related control information is transmitted together with the TB.

In certain embodiments, the method further comprises receiving a logical channel configuration, wherein the logical channel configuration comprises a request for transmission of the retransmission related control information, and the TB comprises uplink data associated with the logical channel configuration.

In one embodiment, an apparatus comprises: a transceiver to: transmit information indicating at least one set of scheduling configurations, wherein each set of scheduling configurations of the at least one set of scheduling configurations comprises at least one scheduling configuration, and each scheduling configuration of the at least one scheduling configuration comprises scheduling information including time domain resource allocations, frequency domain resource allocations, a MCS, or some combination thereof: transmit DCI that indicates activation of a set of scheduling configurations of the at least one set of scheduling configurations for a duration; and perform communications on a plurality of scheduling occasions of the set of scheduling configurations, wherein the plurality of scheduling occasions is within the duration.

In certain embodiments, the DCI comprises at least one resource offset value applied to the time domain resource allocations and the frequency domain resource allocations.

In some embodiments, the DCI comprises information indicating an MCS index offset for a scheduling configuration of the set of scheduling configurations, and wherein performing the communications comprises performing the communications based on an MCS indicated in the scheduling configuration and the MCS index offset.

In various embodiments, the DCI comprises information indicating the duration.

In one embodiment, the DCI comprises an indication of a first priority of the plurality of scheduling occasions, an indication of the first priority related to communications on the plurality of scheduling occasions, or a combination thereof.

In certain embodiments, the communications on the plurality of scheduling occasions comprise a plurality of SPS PDSCHs, and the first priority comprises a second priority of HARQ-ACK information corresponding to the plurality of SPS PDSCHs.

In some embodiments, each scheduling configuration of the at least one scheduling configuration comprises an uplink CG configuration, and the plurality of scheduling occasions comprise a plurality of CG PUSCH occasions.

In various embodiments, the transceiver further to receive an acknowledgement, upon transmitting the DCI, on a CG PUSCH occasion of the plurality of CG PUSCH occasions, wherein the CG PUSCH occasion has an earliest starting symbol among the plurality of CG PUSCH occasions.

In one embodiment, the acknowledgement comprises a joint activation confirmation MAC CE indicating whether a DCI format indicating activation of a set of configured uplink grant configurations has been detected.

In certain embodiments, the DCI format comprises a cyclic shift value, an offset value, or a combination thereof.

In some embodiments, the duration comprises a configured duration or a dynamically indicated duration.

In various embodiments, the duration is selected from a set of possible activation durations.

In one embodiment, the set of possible activation durations is configured via RRC signaling.

In certain embodiments, the DCI indicates a value from the set of possible activation durations, and the value corresponds to the duration.

In some embodiments, each scheduling configuration of the at least one scheduling configuration comprises an independent TB, a different TB, or a combination thereof.

In various embodiments, each scheduling configuration of the at least one scheduling configuration comprises an independently configured HARQ-ACK codebook index, an independently configured physical layer priority index, or a combination thereof.

In one embodiment, each scheduling configuration of the at least one scheduling configuration comprises a same HARQ-ACK codebook index, a same configured physical layer priority index, or a combination thereof.

In certain embodiments, the transceiver further to not perform communications on the plurality of scheduling occasions for a second duration after the duration.

In some embodiments, the transceiver further to receive retransmission related control information, wherein the retransmission related control information comprises information of a remaining valid duration for retransmission of a TB, an indication of no further transmission of the TB, or a combination thereof.

In various embodiments, the retransmission related control information is transmitted together with HARQ-ACK information.

In one embodiment, the retransmission related control information is transmitted together with the TB.

In certain embodiments, the transceiver further to transmit a logical channel configuration, and the logical channel configuration comprises a request for transmission of the retransmission related control information, and the TB comprises uplink data associated with the logical channel configuration.

In one embodiment, a method at a network device, the method comprises: transmitting information indicating at least one set of scheduling configurations, wherein each set of scheduling configurations of the at least one set of scheduling configurations comprises at least one scheduling configuration, and each scheduling configuration of the at least one scheduling configuration comprises scheduling information including time domain resource allocations, frequency domain resource allocations, a MCS, or some combination thereof: transmitting DCI that indicates activation of a set of scheduling configurations of the at least one set of scheduling configurations for a duration; and performing communications on a plurality of scheduling occasions of the set of scheduling configurations, wherein the plurality of scheduling occasions is within the duration.

In certain embodiments, the DCI comprises at least one resource offset value applied to the time domain resource allocations and the frequency domain resource allocations.

In some embodiments, the DCI comprises information indicating an MCS index offset for a scheduling configuration of the set of scheduling configurations, and wherein performing the communications comprises performing the communications based on an MCS indicated in the scheduling configuration and the MCS index offset.

In various embodiments, the DCI comprises information indicating the duration.

In one embodiment, the DCI comprises an indication of a first priority of the plurality of scheduling occasions, an indication of the first priority related to communications on the plurality of scheduling occasions, or a combination thereof.

In certain embodiments, the communications on the plurality of scheduling occasions comprise a plurality of SPS PDSCHs, and the first priority comprises a second priority of HARQ-ACK information corresponding to the plurality of SPS PDSCHs.

In some embodiments, each scheduling configuration of the at least one scheduling configuration comprises an uplink CG configuration, and the plurality of scheduling occasions comprise a plurality of CG PUSCH occasions.

In various embodiments, the method further comprises receiving an acknowledgement, upon transmitting the DCI, on a CG PUSCH occasion of the plurality of CG PUSCH occasions, wherein the CG PUSCH occasion has an earliest starting symbol among the plurality of CG PUSCH occasions.

In one embodiment, the acknowledgement comprises a joint activation confirmation MAC CE indicating whether a DCI format indicating activation of a set of configured uplink grant configurations has been detected.

In certain embodiments, the DCI format comprises a cyclic shift value, an offset value, or a combination thereof.

In some embodiments, the duration comprises a configured duration or a dynamically indicated duration.

In various embodiments, the duration is selected from a set of possible activation durations.

In one embodiment, the set of possible activation durations is configured via RRC signaling.

In certain embodiments, the DCI indicates a value from the set of possible activation durations, and the value corresponds to the duration.

In some embodiments, each scheduling configuration of the at least one scheduling configuration comprises an independent TB, a different TB, or a combination thereof.

In various embodiments, each scheduling configuration of the at least one scheduling configuration comprises an independently configured HARQ-ACK codebook index, an independently configured physical layer priority index, or a combination thereof.

In one embodiment, each scheduling configuration of the at least one scheduling configuration comprises a same HARQ-ACK codebook index, a same configured physical layer priority index, or a combination thereof.

In certain embodiments, the method further comprises not performing communications on the plurality of scheduling occasions for a second duration after the duration.

In some embodiments, the method further comprises receiving retransmission related control information, wherein the retransmission related control information comprises information of a remaining valid duration for retransmission of a TB, an indication of no further transmission of the TB, or a combination thereof.

In various embodiments, the retransmission related control information is transmitted together with HARQ-ACK information.

In one embodiment, the retransmission related control information is transmitted together with the TB.

In certain embodiments, the method further comprises transmitting a logical channel configuration, wherein the logical channel configuration comprises a request for transmission of the retransmission related control information, and the TB comprises uplink data associated with the logical channel configuration.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A user equipment (UE), comprising:
at least one memory; and
at least one processor coupled with the at least one memory and configured to cause the UE to:
receive information indicating at least one set of scheduling configurations, wherein each set of scheduling configurations of the at least one set of scheduling configurations comprises at least one scheduling configuration, and each scheduling configuration of the at least one scheduling configuration comprises scheduling information including time domain resource allocations, frequency domain resource allocations, a modulation and coding scheme (MCS), or some combination thereof;
receive downlink control information (DCI) that indicates activation of a set of scheduling configurations of the at least one set of scheduling configurations for a duration; and
perform communications on a plurality of scheduling occasions of the set of scheduling configurations, wherein the plurality of scheduling occasions is within the duration.

2. The UE of claim 1, wherein the DCI comprises at least one resource offset value applied to the time domain resource allocations and the frequency domain resource allocations.

3. The UE of claim 1, wherein the DCI comprises information indicating an MCS index offset for a scheduling configuration of the set of scheduling configurations, and wherein performing the communications comprises performing the communications based on an MCS indicated in the scheduling configuration and the MCS index offset.

4. The UE of claim 1, wherein the DCI comprises information indicating the duration.

5. The UE of claim 1, wherein the DCI comprises an indication of a first priority of the plurality of scheduling occasions, an indication of the first priority related to communications on the plurality of scheduling occasions, or a combination thereof.

6. The UE of claim 5, wherein the communications on the plurality of scheduling occasions comprise a plurality of semi-persistent scheduling (SPS) physical downlink shared channels (PDSCHs), and the first priority comprises a second priority of hybrid automatic repeat request acknowledgment (HARQ-ACK) information corresponding to the plurality of SPS PDSCHs.

7. The UE of claim 1, wherein each scheduling configuration of the at least one scheduling configuration comprises an uplink configured grant (CG) configuration, and the plurality of scheduling occasions comprise a plurality of CG physical uplink shared channel (PUSCH) occasions.

8. The UE of claim 1, wherein the at least one processor is configured to cause the UE to transmit retransmission related control information, and the retransmission related control information comprises information of a remaining valid duration for retransmission of a transport block (TB), an indication of no further transmission of the TB, or a combination thereof.

9. The UE of claim 8, wherein the retransmission related control information is transmitted together with HARQ-ACK information.

10. The UE of claim 8, wherein the retransmission related control information is transmitted together with the TB.

11. A method at a user equipment (UE), the method comprising:
receiving information indicating at least one set of scheduling configurations, wherein each set of scheduling configurations of the at least one set of scheduling configurations comprises at least one scheduling configuration, and each scheduling configuration of the at least one scheduling configuration comprises scheduling information including time domain resource allocations, frequency domain resource allocations, a modulation and coding scheme (MCS), or some combination thereof;
receiving downlink control information (DCI) that indicates activation of a set of scheduling configurations of the at least one set of scheduling configurations for a duration; and
performing communications on a plurality of scheduling occasions of the set of scheduling configurations, wherein the plurality of scheduling occasions is within the duration.

12. A base station, comprising:
at least one memory; and
at least one processor coupled with the at least one memory and configured to cause the base station to:
transmit information indicating at least one set of scheduling configurations, wherein each set of scheduling configurations of the at least one set of scheduling configurations comprises at least one scheduling configuration, and each scheduling configuration of the at least one scheduling configuration comprises scheduling information including time domain resource allocations, frequency domain resource allocations, a modulation and coding scheme (MCS), or some combination thereof;
transmit downlink control information (DCI) that indicates activation of a set of scheduling configurations of the at least one set of scheduling configurations for a duration; and
perform communications on a plurality of scheduling occasions of the set of scheduling configurations, wherein the plurality of scheduling occasions is within the duration.

13. The base station of claim 12, wherein the DCI comprises at least one resource offset value applied to the time domain resource allocations and the frequency domain resource allocations.

14. The base station of claim 12, wherein the DCI comprises information indicating an MCS index offset for a scheduling configuration of the set of scheduling configurations, and wherein performing the communications comprises performing the communications based on an MCS indicated in the scheduling configuration and the MCS index offset.

15. The base station of claim 12, wherein the DCI comprises information indicating the duration.

16. A processor for wireless communication, comprising:
at least one controller coupled with at least one memory and configured to cause the processor to:
receive information indicating at least one set of scheduling configurations, wherein each set of scheduling configurations of the at least one set of scheduling configurations comprises at least one scheduling configuration, and each scheduling configuration of the at least one scheduling configuration comprises scheduling information including time domain resource allocations, frequency domain resource allocations, a modulation and coding scheme (MCS), or some combination thereof;
receive downlink control information (DCI) that indicates activation of a set of scheduling configurations of the at least one set of scheduling configurations for a duration; and
perform communications on a plurality of scheduling occasions of the set of scheduling configurations, wherein the plurality of scheduling occasions is within the duration.

17. The processor of claim 16, wherein the DCI comprises at least one resource offset value applied to the time domain resource allocations and the frequency domain resource allocations.

18. The processor of claim 16, wherein the DCI comprises information indicating an MCS index offset for a scheduling configuration of the set of scheduling configurations, and wherein performing the communications comprises performing the communications based on an MCS indicated in the scheduling configuration and the MCS index offset.

19. The processor of claim 16, wherein the DCI comprises information indicating the duration.

20. The processor of claim 16, wherein the DCI comprises an indication of a first priority of the plurality of scheduling occasions, an indication of the first priority related to communications on the plurality of scheduling occasions, or a combination thereof.
